(19) United States
(12) Patent Application Publication
(10) Pub. No.: US 2026/0329721 A1
(43) Pub. Date: Oct. 22, 2026

(54) AUTOMATED ARCHITECTURAL DEVIATION DETECTION VIA GRAPH-BASED CODE CHANGE ANALYSIS

(71) Applicant: Kinaxis Inc., Ottawa (CA)

(72) Inventors: Jean-Francois Dubeau, Gatineau (CA); Arslan Shahid, Ottawa (CA); Leila Mousapour, Hamilton (CA); Colton Mackenzie Donkersgoed, Hamilton (CA)

(73) Assignee: Kinaxis Inc., Ottawa (CA)

(21) Appl. No.: 19/648,234

(22) Filed: Apr. 15, 2026

Related U.S. Application Data
(60) Provisional application No. 63/789,709, filed on Apr. 16, 2025.

(51) Int. Cl. G06F 11/3604

(52) U.S. Cl. CPC G06F 11/3608

(57) ABSTRACT

System and methods for architectural compliance verification by transforming code change annotations into a structured graph representation. The process begins by receiving code change annotations and converting them into a graph where nodes and edges represent code entities and their relationships. The system can filter irrelevant changes and encapsulates impactful modifications with specific tags to isolate significant structural updates. A dynamic change graph can then be constructed and algorithmically compared against a static system architecture reference model. This comparison can identify specific architectural deviations that violate defined principles. Upon detecting non-compliant structural changes, the system can generate a detailed architectural assessment report highlighting the violations. By mapping code snippets to graph nodes and performing dynamic-to-static graph comparisons, the solution enables real-time enforcement of software architecture standards, preventing structural drift before it impacts the production environment.

This application claims priority on U.S. Ser. No. 63/789,709 filed on Apr. 16, 2025, which is incorporated herein in its entirety, by reference.

### BACKGROUND

Software systems, including microservice-based and other large-scale applications, commonly evolve through incremental code changes. Over time, the implemented structure may diverge from an intended or reference architecture (sometimes referred to as architectural drift), for example by violating layering constraints, dependency rules, or other design principles. Such divergence can increase coupling and technical debt and can adversely affect maintainability, scalability, and security.

Various approaches attempt to detect or manage architectural drift using static analysis, dependency graphs, rules engines, and/or review workflows. Some systems compare code artifacts against predefined architectural models to identify forbidden dependencies or other policy violations, and some techniques analyze historical changes to infer architectural evolution. However, these approaches may have limited ability to correlate in-progress code modifications with a reference architecture in a manner that reliably differentiates benign refactoring from changes that meaningfully alter architectural structure.

In practice, existing techniques can produce excessive alerts (e.g., false positives) or may fail to identify certain architectural violations until late in a development cycle. Manual review can be time-consuming and error-prone, and periodic scanning may not reflect cascading effects across distributed components. Accordingly, there is a need for improved techniques that identify and/or enforce architectural compliance during software development with reduced noise and improved assessment of structural impact.

### BRIEF SUMMARY

Described herein are systems and methods that process code change annotations to construct a change graph and filter tagged, non-impactful modifications to focus analysis on structurally relevant updates. The change graph is compared to a reference system architecture model to identify architectural drift or non-compliance at or before code submission, and an assessment report is generated that identifies detected deviations.

In one aspect, a computing apparatus is provided, that includes a processor. The computing apparatus also includes a memory storing instructions that, when executed by the processor, configure the apparatus to: receive code changes included in the pull request; identify, from the code changes, one or more relevant code changes having a potential to cause architectural impact; filter one or more irrelevant code changes from the code changes; and annotate the one or more relevant code changes by encapsulating the one or more relevant code changes with one or more tags indicating a type of change.

When identifying the one or more relevant code changes, the apparatus may be configured to: provide a specialized prompt to a large language model configured to identify code changes having the potential to cause architectural impact. The computing apparatus may also include where the one or more tags include an added tag, a deleted tag, and a modified tag. The computing apparatus may also include where the one or more relevant code changes include code changes that alter structural relationships, introduce new dependencies, modify infrastructure configuration, or affect service interactions. When filtering the one or more irrelevant code changes, the apparatus may be configured to filter at least one of unit tests, formatting changes, documentation changes, or cosmetic refactors. The computing apparatus may be integrated with a continuous integration and continuous deployment pipeline to provide real-time feedback of architectural impact during review of the pull request. Other technical features may be readily apparent to one skilled in the art from the following figures, descriptions, and claims.

In one aspect, a non-transitory computer-readable storage medium is provided, the computer-readable storage medium including instructions that when executed by a computer, cause the computer to: receive code changes included in the pull request; identify, from the code changes, one or more relevant code changes having a potential to cause architectural impact; filter one or more irrelevant code changes from the code changes; and annotate the one or more relevant code changes by encapsulating the one or more relevant code changes with one or more tags indicating a type of change.

When identifying the one or more relevant code changes, the computer may be configured to provide a specialized prompt to a large language model configured to identify code changes having the potential to cause architectural impact. The non-transitory computer-readable storage medium may also include where the one or more tags include an added tag, a deleted tag, and a modified tag. The non-transitory computer-readable storage medium may also include where the one or more relevant code changes include code changes that alter structural relationships, introduce new dependencies, modify infrastructure configuration, or affect service interactions. When filtering the one or more irrelevant code changes, the computer may be configured to filter at least one of unit tests, formatting changes, documentation changes, or cosmetic refactors. The non-transitory computer-readable storage medium may be integrated with a continuous integration and continuous deployment pipeline to provide real-time feedback of architectural impact during review of the pull request. Other technical features may be readily apparent to one skilled in the art from the following figures, descriptions, and claims.

In one aspect, a computer-implemented method for annotating code changes associated with a pull request is provided. The method includes: receiving, by a processor, code changes included in the pull request; identifying, by the processor, from the code changes, one or more relevant code changes having a potential to cause architectural impact; filtering, by the processor, one or more irrelevant code changes from the code changes; and annotating, by the processor, the one or more relevant code changes by encapsulating the one or more relevant code changes with one or more tags indicating a type of change.

The computer-implemented method may also include where identifying the one or more relevant code changes includes providing, by the processor, a specialized prompt to a large language model configured to identify code changes having the potential to cause architectural impact. The computer-implemented method may also include where the one or more tags include an added tag, a deleted tag, and a modified tag. The computer-implemented method may also include where the one or more relevant code changes include code changes that alter structural relationships, introduce new dependencies, modify infrastructure configuration, or affect service interactions. The computer-implemented method may also include where filtering the one or more irrelevant code changes includes filtering at least one of unit tests, formatting changes, documentation changes, or cosmetic refactors. The computer-implemented method may also be integrated with a continuous integration and continuous deployment pipeline to provide real-time feedback of architectural impact during review of the pull request. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter may become apparent from the description, the drawings, and the claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for automated architectural deviation detection in accordance with one embodiment.

FIG. 2 illustrates a system architecture diagram in accordance with one embodiment.

FIG. 3 illustrates a block diagram in accordance with one embodiment.

FIG. 4 illustrates a block diagram for relevant code change annotation in accordance with one embodiment.

FIG. 5 illustrates a block diagram for conversion to graph representation in accordance with one embodiment.

FIG. 6 illustrates a block diagram for identification of architectural deviation in accordance with one embodiment.

FIG. 7 illustrates a block diagram for producing an architectural assessment report in accordance with one embodiment.

FIG. 8A-FIG. 8C illustrates an example of relevant code changes in a pull request, in accordance with one embodiment.

FIG. 9A-FIG. 9C illustrates an example of an architecture impact report based on the relevant code change shown in FIG. 8A-FIG. 8C. FIG. 9A illustrates a summary of the results of subroutine block 304 as applied to the example shown in FIG. 8A-FIG. 8C.

FIG. 9B illustrates a summary of the results of subroutine block 306 as applied to the example shown in FIG. 8A-FIG. 8C.

FIG. 9C illustrates a summary of the results of subroutine block 308 as applied to the example shown in FIG. 8A-FIG. 8C.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit including custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, include one or more physical or logical blocks of computer instructions which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which includes one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

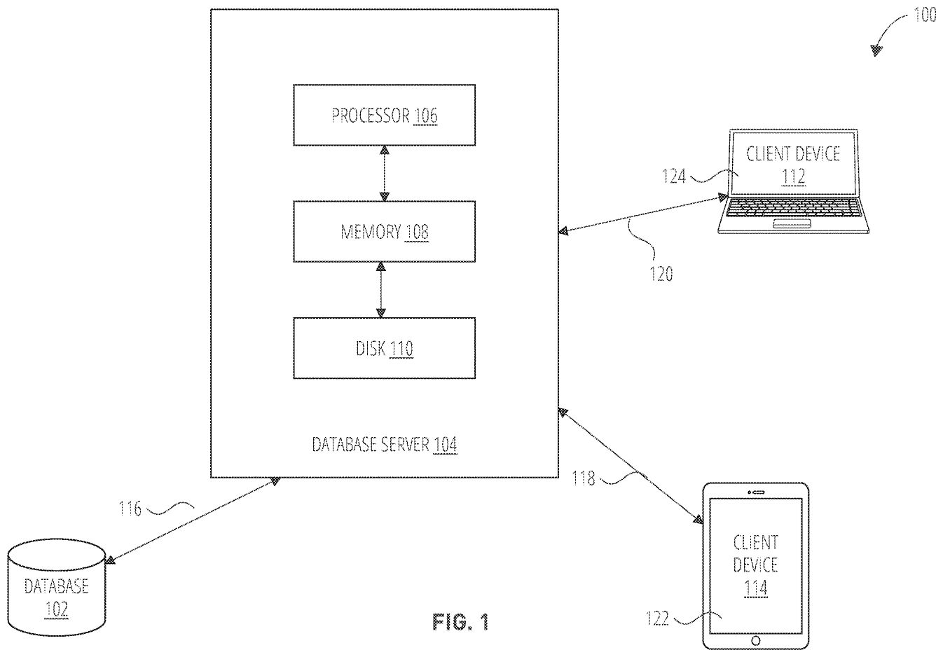

FIG. 1 illustrates an example of a system 100 for automated architectural deviation detection, in accordance with one embodiment.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also include a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

In the present disclosure, the terms “process” and “algorithm” are used interchangeably, and may refer to a set of steps performed in relation to an in-memory database, such as a versioned database. As referred to herein, for example, a deterministic process may be considered to be equivalent to a deterministic algorithm. A deterministic algorithm always produces the same output given a particular input. For example, an algorithm that always returns an output of Y with an input of X is deterministic. So, every time there is an input of X, it is known that the answer is Y. The result does not have to be unique, for example an input of Q can also return an output of Y, just deterministic. For a deterministic algorithm, once the input is known, the answer or output is already known, and it is not necessary to send the input to the algorithm at all.

In some implementations, a server memory may store an in-memory database as well as calculated results from processes or algorithms that are executed in relation to contents of the in-memory database. In some implementations, the calculated results may include about half of the server memory.

Reference to “in-memory” storage may refer to a server memory associated with database server 104, which may include memory 108 and/or database 102. Reference to “on-disk” storage may refer to disk 110 and/or other disks, for example disks associated with cloud storage.

In known approaches, both data (e.g. a versioned database) and calculations (e.g. calculated results) are stored in-memory. Such an approach is fast but also expensive. There is also a drawback that calculated results stored in-memory do not persist to disk when the server is restarted. The first time a calculation is performed, not only do all of the records need to be in-memory, but also the calculation structures must be built up in memory.

Embodiments of the present disclosure save memory and improve performance. Embodiments of the present disclosure avoid the time required to re-calculate the results, even the first time after server startup. Servers may have complicated invalidation rules. Even if something is stored in-memory, if the database changes, the results may be incorrect. Analytics results may also be lost from memory if the server detects that it is running out of memory. Embodiments of the present disclosure seek to solve one or more problems associated with known approaches, including wasted time and resources spent recalculating results.

A deterministic process as referred to herein may include an embedded algorithm, such as a supply chain algorithm used to analyze or calculate results based on an in-memory versioned database. An embedded algorithm may be implemented as a TypeScript algorithm. A deterministic process may include a core algorithm the results of which may not be serializable, for example if they are in-memory C++ objects that refer to other memories and other pointers.

Embodiments of the present disclosure may establish two tiers of storage, where the system may promote or demote a result. According to known approaches, some databases only exist in-memory, or only on-disk. Embodiments of the present disclosure provide a method of demoting content from in-memory to on-disk, or promoting content from on-disk to in-memory, for example in response to a server command or indication. If a result is not previously calculated, it can go from nowhere to in-memory or on-disk. In-memory is typically one tier, but on-disk can be one or more tiers. Embodiments of the present disclosure may be configured to provide an n-tier solution, for example where cloud storage provides different types of disks with different speeds of access, and the system may promote/demote to faster or slower disks in different on-disk tiers. Promoting/demoting refers to moving the results around, and is with respect to speed of access to the memory or disk(s).

Disclosed herein are systems and methods for architectural compliance verification by transforming code change annotations into a structured graph representation. The process begins by receiving code change annotations and converting them into a graph where nodes and edges represent code entities and their relationships. The system can filter irrelevant changes and encapsulates impactful modifications with specific tags to isolate significant structural updates. A dynamic change graph can then be constructed and algorithmically compared against a static system architecture reference model. This comparison can identify specific architectural deviations that violate defined principles. Upon detecting non-compliant structural changes, the system can generate a detailed architectural assessment report highlighting the violations. By mapping code snippets to graph nodes and performing dynamic-to-static graph comparisons, the solution enables real-time enforcement of software architecture standards, preventing structural drift before it impacts the production environment.

Systems and methods disclosed herein can perform a number of functions, including analysis and visualization of architectural impact, integration with existing CI/CD pipelines, ensuring consistency and compliance, and enhancing collaboration and communication. With respect to analysis and visualization of architectural impact, systems and methods disclosed herein can provide a comprehensive analysis of how code changes in one repository, affect the overall system architecture, including dependencies and potential conflicts. With respect to integration with existing CI/CD pipelines, systems and methods disclosed herein can seamlessly integrate with current continuous integration and continuous deployment (CI/CD) workflows to provide real-time feedback on architectural impacts during the development process. With respect to ensuring consistency and compliance, systems and methods disclosed herein can automatically enforce architectural standards and guidelines, ensuring that all code changes adhere to predefined architectural principles.

With respect to enhancing collaboration and communication, systems and methods disclosed herein can offer a collaborative platform where developers, architects, and other stakeholders can easily understand and discuss the architectural implications of code changes.

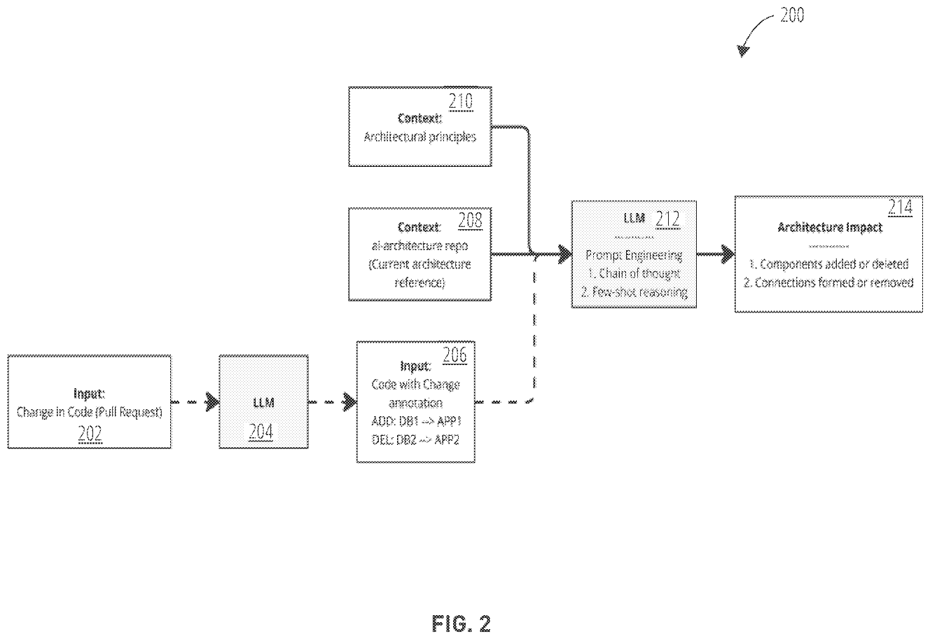

FIG. 2 illustrates a system architecture diagram 200 in accordance with one embodiment.

An AI agent takes a pull request (PR) as input at block 202, which includes the proposed code changes. This input can be parsed and analyzed to identify the modified, added, or deleted code components. This step can leverage a first Large Language Model (LLM) at block 204 to capture only the relevant information from the PR in the form of code delta with enough code context required to understand the nature of the change.

The code with change annotation is provided at block 206, and can serve as input for a second Large Language Model at block 212. A first context for the second LLM can be provided by a current architecture reference at block 208, and a second context for the second LLM can be provided by architecture principles at block 210. The first and second LLMs may be distinct or identical. Prompt Engineering of the second LLM at block 212 can include chain of thought, and few-shot reasoning. The second LLM at block 212 can be used to generate an Architecture Impact Report at block 214. The Architecture Impact Report can include components that have been added or deleted, as well as connections that have been formed or removed.

In some embodiments, Large Language Models are used to parse pull requests across multiple repositories, identifying impactful code changes while filtering out irrelevant modifications like unit tests and tagging them as added, deleted, or modified. This approach significantly reduces the noise in architectural analysis by focusing only on structural changes, thereby saving computational resources and improving the accuracy of impact assessments.

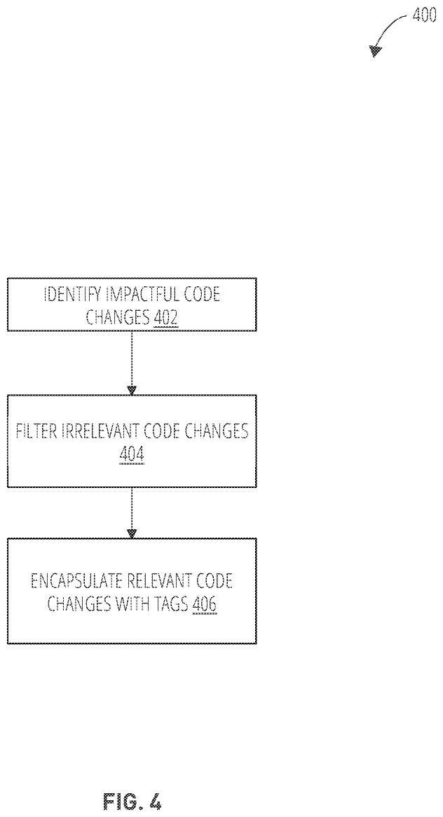

A structural change in a unit test file can be distinguished from a structural change in a production file, by using LLMs to parse code and identify segments pertinent to architectural elements (modules, services, databases, containers, pods, etc.). Code that contains business logic or test logic running inside a resource (but does not impact the architecture diagram) can be classified as irrelevant and filtered out, as shown below in subroutine block 302 and FIG. 4.

Instead of relying on training data or fine-tuning strategies to ensure that the LLM correctly identifies ‘impactful’ changes across different programming languages, the system can provide the LLM with a predefined list of all possible architectural resource types (e.g., deployments, services, pods, ingresses) and example pairs of user code with corresponding diagram code to guide identification.

In addition, false positives can be handled where a change is tagged as impactful but has no actual architectural consequence, as follows. A multi-step pipeline (identify relevant code→identify resources→annotate→generate) can act as successive filtering stages where each subsequent step cross-references and validates the output of the prior step.

In FIG. 2, Code Change Annotation (block 206) is a specialized component that can be used to interpret and annotate code changes, thereby reducing human error and increasing the accuracy of architectural impact assessments. Furthermore, Graph Representation of Code Changes allows an AI agent to think through a series of intermediate steps which is foundational to accessing architectural impact. This has a large impact on accuracy of the agent output. A method of representing code changes as a graph provides a clear, visual understanding of architectural impacts and facilitates a human-in-the-loop model, thereby enabling practical automation. Contextual Reference Architecture Comparison is based on the use of a current system reference architecture (block 208) as context to compare an updated graph and identify deviations, thereby ensuring alignment with a desired architecture.

Systems and methods disclosed herein include the development and implementation of an AI-driven system that automates the assessment of architectural impact for code changes. This solution can leverage state-of-the-art large language models (LLMs) to build an AI agent that can provide comprehensive and actionable insights into the architectural implications of code changes (pull requests) in a repository.

By implementing such an automated solution, the risk of architectural degradation is greatly reduced. Furthermore, the efficiency and accuracy of the code review process is improved. There is enhanced visibility and traceability, while consistent architectural standards are maintained across the codebase. This provides for a more robust, scalable, and maintainable system, enabling for the delivery of high-quality software more rapidly and reliably.

Systems and methods disclosed herein can include a number of elements, such as an AI annotator of code changes, an AI code-to-graph converter, a current architectural reference, architectural principles and standards, and an AI architecture report generator. Each of these is described below.

### AI annotator of Code Changes

Input Processing: The AI agent takes a pull request (PR) as input, which includes the proposed code changes. This input is parsed and analyzed to identify the modified, added, or deleted code components. This step leverages Large Language Model (LLM) to capture only the relevant information from the PR in the form code delta with enough code context required to understand the nature of the change.

### AI Code to Graph Converter

Intermediate Representation: The AI agent can convert the code changes into an intermediate representation where all components (e.g., modules, services, and the like) can be represented as nodes, and the connections (e.g., dependencies, interactions, and the like) between them can be represented as edges in a graph. The changes in the code can be mapped onto the existing graph, updating the nodes and edges accordingly. This step helps to ensure that the graph accurately reflects the current state of the system after the proposed changes.

This step allows the Large Language Model (LLM) to think through a series of intermediate steps which is foundational to accessing architectural impact. Furthermore, the intermediate graph representation can provide a clear, visual understanding of architectural changes and can facilitate a human-in-the-loop model, thereby enabling practical automation.

### Current Architectural Reference

Contextual Reference Architecture: The system reference architecture, which defines the current state of the system, can be provided to the AI agent as context. The AI agent may compare the updated graph with the reference architecture to identify any deviations from it.

### Architectural Principles and Standards

Contextual Architecture Principles: The system architecture principles, which define the desired architectural practices and standards, can be provided to the AI agent as context.

### AI Architecture Report Generator

Generation of Architectural Impact Report: The AI agent may use information from all the previous steps and prepares an architectural impact report.

Systems and methods disclosed herein can combine these elements, described below.

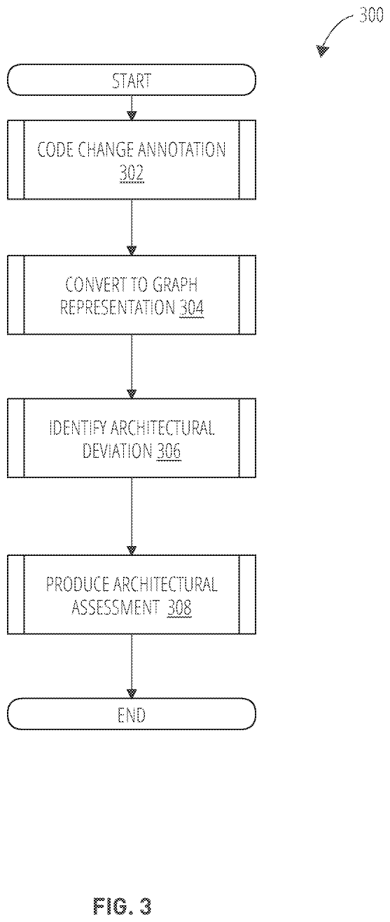

FIG. 3 illustrates a block diagram 300 in accordance with one embodiment.

The first step can include code changes annotation at subroutine block 302. This can allow for code changes annotation in which code changes are identified and annotated, as follows. When a pull request (PR) is submitted, the AI agent begins by parsing and annotating the code changes. This can be accomplished with a specialized prompt to a large language model (LLM) that enables it to follow a two-step approach, which includes: i) identifying relevant code; and ii) annotating relevant code. Subroutine block 302 is described further in block diagram 400 in FIG. 4.

A next step can include conversion of annotated code changes to graph representation at subroutine block 304. These annotated changes can be converted into a graph representation. This transformation from code changes to a structured graph can form the basis for visualizing and understanding the architectural impact.

At 304, raw code change annotations are transformed into a structured graph where nodes represent code entities and edges represent their relationships to visualize structural updates. This approach provides a precise, context-aware model of code changes that allows for accurate differentiation between benign modifications and significant structural deviations.

Specific attributes of nodes and edges can be defined to ensure that they capture all necessary architectural relationships, as follows. In some embodiments, nodes may represent code entities (services, components, config maps, secrets) with properties such as name, description, technology, and tags. Edges can capture relationships between entities with descriptive labels and technology annotations (e.g., serviceA->cosmosdb “Reads/Writes data” “REST/HTTPS”), derived from architecture-as-code DSL patterns.

Different programming languages can be mapped to a unified graph schema. In some embodiments, the LLM abstracts language-specific syntax into a common architecture-as-code DSL (e.g., Structurizr) where all entities become typed nodes (components, services, etc) with standardized properties and edges—the graph schema is language-agnostic by design.

There can be mechanism used to handle cyclic dependencies within the generated graph. In some embodiments, the system can be modeled as a directed graph (not a tree), so that cyclic dependencies are naturally preserved. Subsequently, a deviation identification step (see subroutine block 306 below) can compare graph structures holistically by matching nodes and edges rather than traversing paths, so that cycles do not block the comparison.

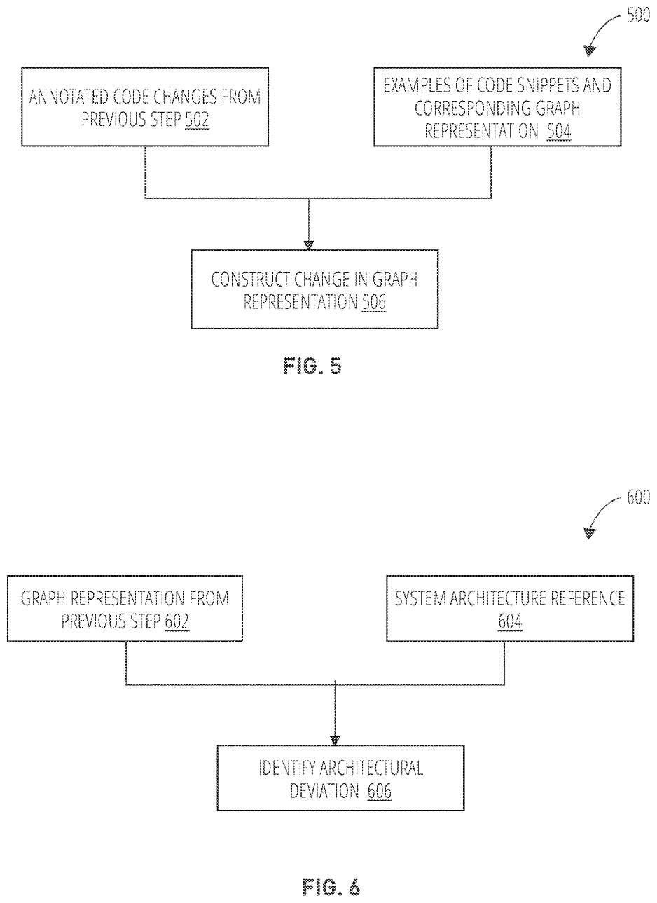

In addition, there can be a scale-up when processing large-scale monolithic codebases. The system operates on a PR delta, rather than the full codebase, and subroutine block 302 further filters out architecturally irrelevant changes (e.g., unit tests, formatting), so only impactful modifications flow into graph conversion. Subroutine block 304 is described further in block diagram 500 in FIG. 5.

Computational overhead for generating the graph for large-scale repositories is minimized since the process operates on a PR delta, not the full codebase. Therefore, only a small, relevant subset of code is ever converted to graph form.

In some embodiments, dynamic language features (for example, reflection or metaprogramming) can be handled as follows. The LLM-based annotation step interprets code semantically, rather than relying on static parsing, so it can reason about the intent of reflective or meta programmed constructs and map them to architectural entities in the graph based on their observable effect on system structure.

Next, at subroutine block 306, architectural deviation is identified. The AI agent can use a current system architecture reference as a contextual baseline. Subroutine block 306 is described further in block diagram 600 in FIG. 6.

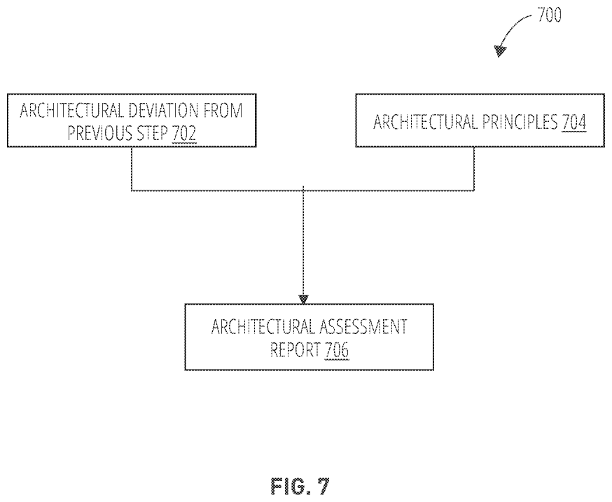

A next step can include ensuring adherence to architectural standards by assessing the code changes to ensure they comply with established best practices at subroutine block 308, which is described further in block diagram 700 in FIG. 7.

A next step can include real-time feedback integration. This can allow for CI/CD pipeline integration, as follows. The system can integrate with continuous integration and continuous deployment (CI/CD) workflows. As code changes are committed, the AI agent can provide real-time feedback on architectural impacts. This allows developers to address issues promptly, improving the efficiency and accuracy of the development process.

FIG. 4 illustrates a block diagram 400 for relevant code change annotation in accordance with one embodiment.

As shown below, the process filters out irrelevant changes and encapsulates significant structural updates with specific tags to isolate modifications that affect architectural integrity. Filtering reduces noise and false positives, ensuring that developers only receive alerts regarding changes that genuinely threaten the system's design principles.

As discussed with respect to subroutine block 302 in FIG. 3, when a pull request (PR) is submitted, the AI agent begins by parsing and annotating the code changes. This can be accomplished with a specialized prompt to a large language model (LLM) that enables it to follow a two-step approach, which includes: i) identifying relevant code; and ii) annotating relevant code. Each of these is briefly described as follows.

Identify relevant code at block 402. The first step in this process is to identify which code changes in the pull request have the potential to cause architectural impact. This information is used at block 404, where irrelevant code changes are filtered out; it allows later steps better focus on the important information. For example, code to add a unit test is irrelevant, whereas code to add and use a new secret in Kubernetes is relevant.

Changes can be defined as ‘impactful’ versus ‘benign’ in the filtering logic. For example, changes that alter structural relationships, introduce new dependencies, modify infrastructure configuration (e.g., secrets, configuration maps), or affect service interactions are deemed impactful. On the other hand, changes such as unit tests, formatting, documentation, and cosmetic refactors are filtered as benign.

Annotate relevant code at block 406. The second step is to annotate the code changes to clearly differentiate between what was added, removed and modified in the code. That is, at block 406, relevant code changes can be encapsulated with added, deleted and modified tags. This can be accomplished by encapsulating the code changes in <added>, <deleted> and <modified> tags.

As an example:

<added>
configMapRef:
   name: serviceA-cosmosdb-configs
secretRef:
   name: serviceA-cosmosdb-secrets
</added>

In some embodiments, specific tags can be generated and customized for different architectural patterns. For example, tags (<added>, <deleted>, <modified>) can be generated by the LLM during annotation to encapsulate the nature of each change. The tagging vocabulary can be extended through example pairs provided to the LLM, allowing customization for different architectural patterns or DSL conventions.

The tagging mechanism can support version control history to track the evolution of specific tags. Since the system processes PRs within a CI/CD pipeline, each assessment and its tagged annotations are tied to a specific commit; over successive PRs, this creates a natural version-controlled history of architectural changes that can be traced through the repository's commit log.

A number of technical effects ensue from the steps shown in FIG. 4.

Receiving the code changes included in the pull request, allows an analysis to be performed on the proposed change set at review time-rather than on an entire codebase snapshot. This step enables the system to capture the pull request delta with adequate code context to determine what components were added, deleted, or modified, thereby reducing the amount of data carried into subsequent processing and supporting timely architectural assessment during the pull request workflow.

Identifying, from the code changes, one or more relevant code changes having a potential to cause architectural impact allows the system to distinguish structurally meaningful changes from ordinary edits. This step enables later processing to focus on changes that, for example, alter structural relationships, introduce dependencies, modify infrastructure configuration, or affect service interactions, so the assessment is directed to code changes that are more likely to affect architectural integrity instead of treating all changed code uniformly.

Filtering one or more irrelevant code changes from the code changes based on the identifying allows benign pull request content to be removed before downstream analysis. This step enables the system to reduce noise and false positives by excluding changes such as unit tests, formatting changes, documentation changes, or cosmetic refactors when those changes are not architecturally material, while also reducing computational overhead by limiting subsequent graph generation and deviation analysis to a smaller and more relevant subset of the pull request.

Annotating the one or more relevant code changes by encapsulating the one or more relevant code changes with one or more tags indicating a type of change allows the remaining architecturally relevant changes to be represented in a structured form that preserves how the code changed. This step enables added, deleted, and modified portions to be differentiated in a consistent manner so that downstream graph conversion and architectural deviation detection can operate on a more meaningful intermediate representation of the pull request delta, improving focus on material structural updates.

FIG. 5 illustrates a block diagram 500 for conversion to graph representation in accordance with one embodiment. To accomplish this, systems and methods disclosed herein can leverage some examples pairs of code changes and their corresponding graph representations to assist a large language model (LLMs) in the understanding of it. A large language model (LLM) is presented with examples of code snippets and their corresponding graph representation (block 504), along with the annotated code changes (block 502) obtained from previous step (block 406 in FIG. 4), to construct changes in graph representation at block 506.

The disclosed method converts annotated code changes into a graph representation where components are mapped as nodes and dependencies as edges, using the LLM to interpret code snippets and their respective graph structures. Transforming code into a visualizable graph format allows for a unified view of system dependencies, making it easier to detect complex inter-repository impacts that are invisible in linear code reviews.

There can be different mechanisms to ensure the consistency of node and edge definitions when the LLM processes code from different repositories with varying coding standards. For example, predefined annotation rules and diagram constraints are applied uniformly across all repositories, and cross-references cam be extracted data against a canonical list of architectural resource types to ensure consistent labeling (e.g., a Kubernetes deployment is always tagged as “Kubernetes—deploy”).

In addition, the graph generation process can be scaled, when dealing with massive codebases containing millions of lines of code. For example, the system can first filter out irrelevant code in subroutine block 302, so that only architecturally significant segments are passed downstream, significantly reducing the volume of code the LLM must process for resource identification, annotation, and diagram generation.

Overall, combination of a comprehensive resource type list, annotation rules, diagram constraints, DSL syntax rules, and example code-to-diagram pairs, are used to guide the LLM toward correct mappings.

Continuing with the above example:

### Input Code Changes:

<added>
configMapRef:
   name: serviceA-cosmosdb-configs
secretRef:
   name: serviceA-cosmosdb-secrets
</added>

### Changes in Graph Representation:

<added>
   serviceA-cosmosdb-configs =component “CosmosDB ConfigMap” {
description “ConfigMap for CosmosDB configuration”
technology “Kubernetes ConfigMap”
tags “Kubernetes-configmap”
properties {
   “Name”“serviceA-cosmosdb-configs”
}
   }
   serviceA-cosmosdb-secrets =component “CosmosDB Secret” {
description “Secret for CosmosDB credentials”
technology “Kubernetes Secret”
tags “Kubernetes-secret”
properties {
   “Name”“serviceA-cosmosdb-secrets”
}
   }
   </added>

FIG. 6 illustrates a block diagram 600 for identification of architectural deviation in accordance with one embodiment. At block 602, graph representation obtained from previous step (block 506 in FIG. 5) along with a system architecture reference (block 604) can be used by the large language model (LLM) to identify any deviations or misalignments from the desired architectural state at block 606. This can ensure that changes are evaluated in the context of the entire system's architecture. In addition, this comparison can enable real-time detection of architectural drift by directly mapping implementation changes against intended design principles before they reach production.

In summary, disclosed herein are systems and methods that compare the generated graph representation against a provided system reference architecture to automatically identify deviations that violate established architectural principles. Automating the comparison against a reference architecture ensures consistent enforcement of standards across all teams, preventing architectural drift and reducing the accumulation of technical debt.

The system reference architecture lives in a well-maintained code repository that can be updated at least every release to avoid it being stale, and thus avoid causing version mismatches between the reference and other codebases.

While it may seem plausible to use criteria to classify a deviation as critical versus minor in the context of architectural integrity, the system does not explicitly define specific severity classification criteria for deviations; the system detects deviations between code changes and the existing architecture. Criticality assessment, if any, comes from the LLM's knowledge of the software domain.

Certain algorithms can be employed to efficiently match dynamic graph structures against the static reference model. For example, subgraph matching and difference detection can be used: component names, relationship labels, and technology annotations can serve as matching keys to identify where the change graph diverges from the reference architecture.

Specific algorithms can be used to calculate the similarity or deviation score between graphs. As an example, node-and-edge matching can be used based on component names, relationship labels, and technology annotations as matching keys—the LLM performs structural subgraph comparison to identify where the change graph introduces, removes, or alters entities relative to the reference.

In addition, the system can handle cases where the reference architecture model itself needs to evolve over time. For example, the reference architecture can be read from the repository at runtime (not hardcoded), so updates to the architecture-as-code models can be automatically picked up. Gap detection can also flag when changes introduce patterns absent from the reference, prompting architects to update it.

In some embodiments, there can be a tolerance threshold for minor deviations that should not trigger a violation report. Filtering at block 404 (in FIG. 4) can act as a tolerance control by excluding non-architectural changes. Once a change passes filtering and a structural deviation is confirmed against the reference, it is always reported; the assessment report provides dimensional context (performance, security, etc.) so reviewers can judge severity.

Continuing with the above example:

### Architectural Reference Contains:

serviceA->mongodb “Reads/Writes data”

### Input From Previous Step:

serviceA->cosmosdb “Reads/Writes data”

### Architectural Deviation:

ServiceA reads/writes to CosmosDB instead of MongoDB

FIG. 7 illustrates a block diagram 700 for producing an architectural assessment report in accordance with one embodiment.

Ensuring adherence to architectural standards can be achieved by assessing the code changes to ensure they comply with established best practices. This can allow for compliance of principles and standards as follows. Here, the AI agent can be provided with the architectural principles and standards (block 704) along with the architectural deviation (block 702) obtained from previous step (at block 606 of FIG. 6). The AI Agent can use these guidelines to assess the code changes and ensure they comply with established best practices. An architectural assessment can be produced at block 706.

In some embodiments, upon detecting non-compliant structural changes, a detailed report highlighting specific violations and their locations within the codebase, is generated. This feature reduces manual effort for architects and developers by providing immediate, actionable feedback that prevents the accumulation of technical debt.

The generated assessment reports can include a format and level of detail that is useful for developers. For example, the architectural assessment report generated by subroutine block 308 (in FIG. 3) can provide a comprehensive, multi-dimensional evaluation. In an embodiment, the report covers: (1) structural changes describing how the fundamental system structure is altered, (2) performance implications of the change, (3) security considerations, (4) maintainability impact, (5) scalability characteristics, (6) interoperability effects on other systems, (7) compliance and standards adherence, (8) cost implications, (9) user experience impact, and (10) risk management considerations.

In addition, the reporting system can integrate directly with existing CI/CD pipelines to block non-compliant merges. The system takes a PR as input and produces the assessment as output, so it can be triggered as a CI/CD step during PR review to provide real-time feedback and block non-compliant merges before they reach production.

Furthermore, multiple violations can be prioritized if a single commit introduces several architectural breaches. When a single commit introduces multiple architectural deviations, the system can capture all of them during the subroutine block 306 comparison and can then report them collectively in the subroutine block 308 assessment report. Prioritization can be driven by the architectural principles and standards provided as context to the report generation step.

With respect to FIG. 2, the final step involves feeding architectural principles, the current architecture reference, and identified deviations into an LLM to generate a detailed report covering structural changes, performance implications, security considerations, and compliance status. Providing a holistic report that includes security and performance implications alongside structural changes gives architects and developers a complete picture of the risks associated with a code change before merging.

It is possible to ensure that the generated report adheres to specific organizational compliance requirements without hallucinating non-existent regulations. In some embodiments, the system grounds the LLM by providing it with predefined diagram constraints, annotation rules, DSL syntax rules, and concrete example pairs, which constrain the output to factual, context-based information rather than unconstrained generation.

The final report can be delivered in any format; furthermore, it can be integrated directly into existing CI/CD pipelines or ticketing systems. In some embodiments, the final output is delivered as diagram code in a Domain Specific Language (DSL) format such as Structurizr DSL or UML, which is relatively easy to integrate into a CI/CD pipelines or ticketing systems.

The system does not explicitly address conflict resolution in situations where conflicting information between different contexts is provided to the LLM during report generation. Instead, the system can cross-reference extracted data against canonical resource lists and can apply consistent annotation rules and diagram constraints to minimize contradictions across multiple repository inputs.

Continuing with the above example:

### Input From Previous Step:

ServiceA reads/writes to CosmosDB instead of MongoDB

An example of an architectural assessment report is as follows:

### Architectural Impact Detected With Following Implications

1. Structural Changes: The fundamental structure of the system is altered by replacing MongoDB configurations and secrets with CosmosDB configurations and secrets.
2. Performance Implications: The change from MongoDB to CosmosDB could have performance implications depending on the specific use case and workload characteristics.
3. Security Considerations: The security posture is impacted by changing the secrets from MongoDB to CosmosDB.
4. Maintainability: The maintainability might be affected as the team needs to manage and understand CosmosDB configurations and secrets instead of MongoDB.
5. Scalability: The scalability characteristics might change depending on the differences between MongoDB and CosmosDB.
6. Interoperability: The system's ability to interact with other systems might be affected if there are dependencies on MongoDB-specific features.
7. Compliance and Standards: The change should be reviewed to ensure compliance with any relevant standards or regulations.
8. Cost Implications: There could be cost implications due to the change in the database service.
9. User Experience: The end-user experience might be indirectly affected if the performance or reliability of the backend changes.
10. Risk Management: The change introduces new risks associated with the migration from MongoDB to CosmosDB.

### System Input/Output Example

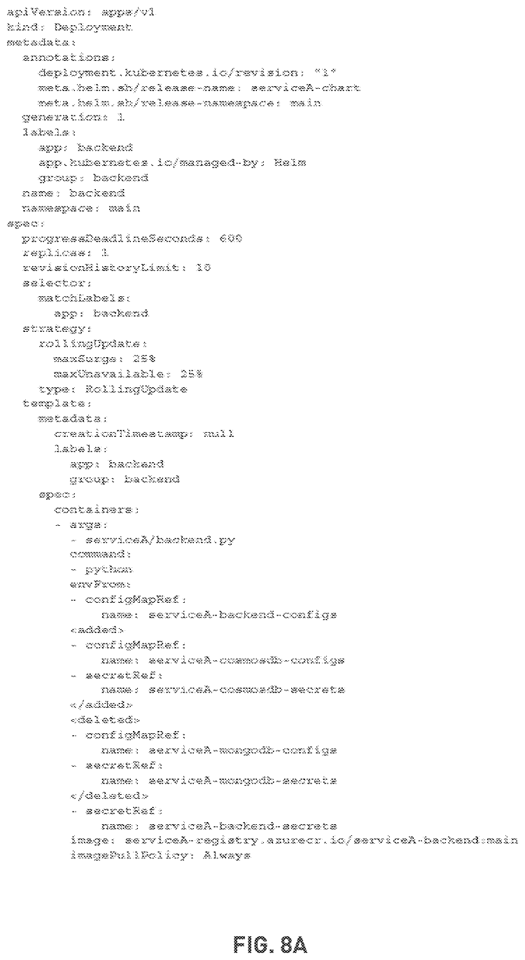

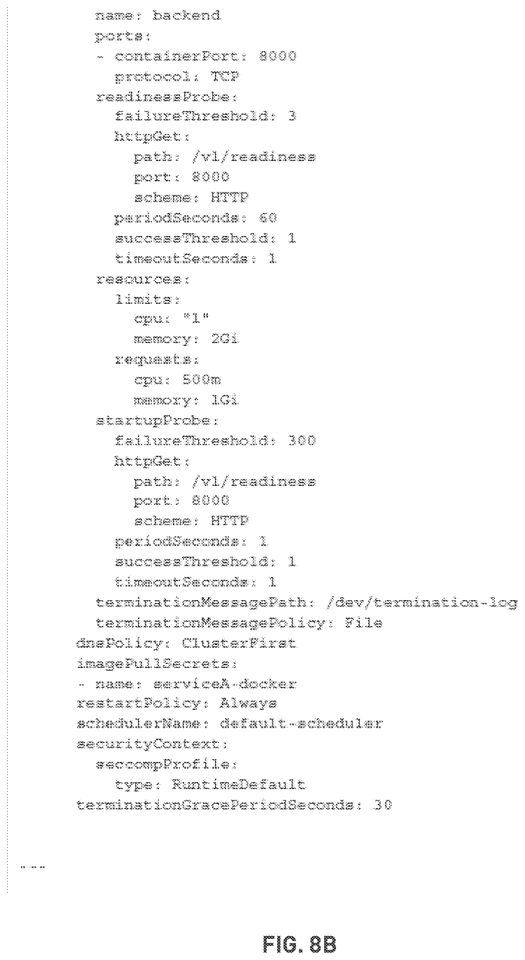

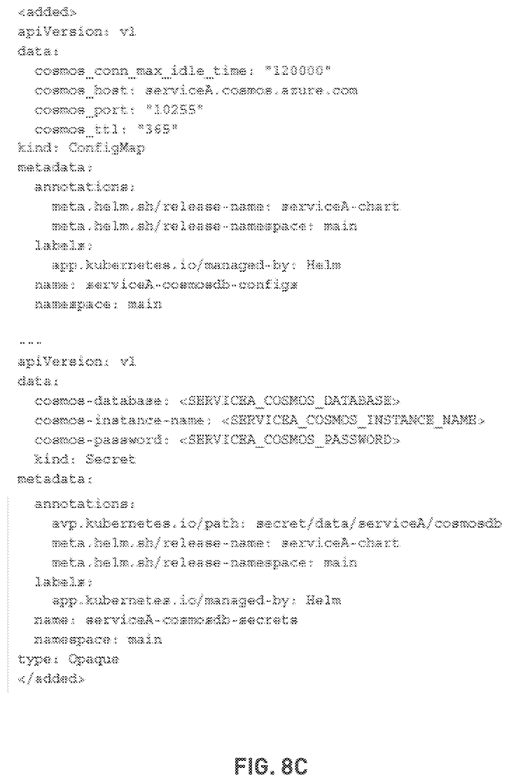

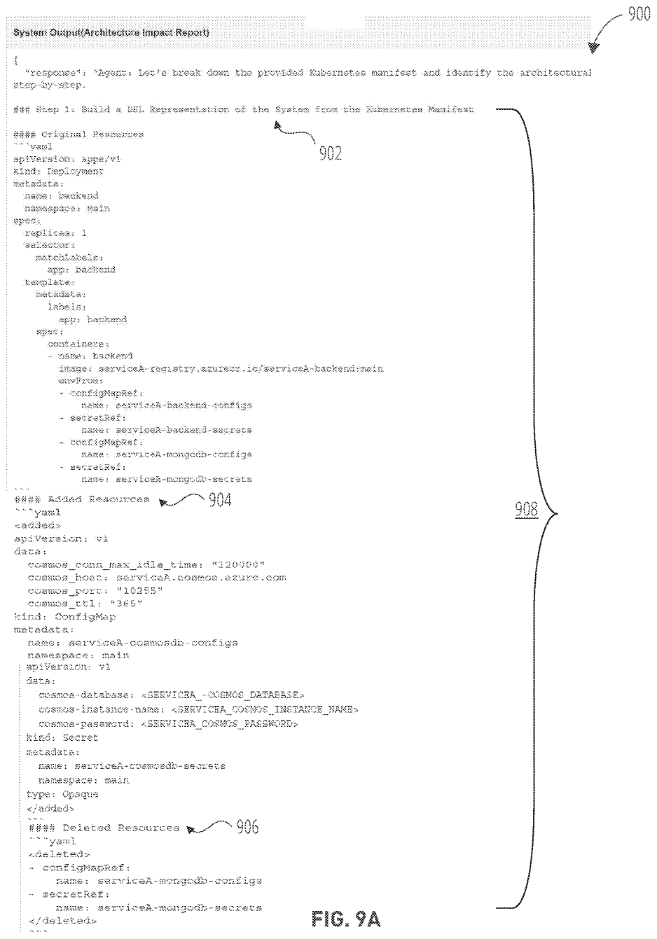

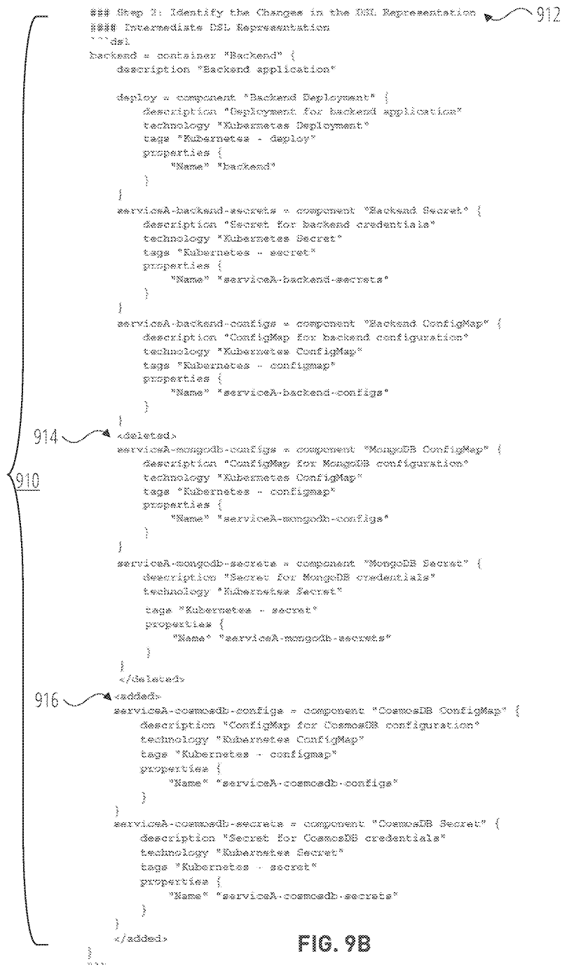

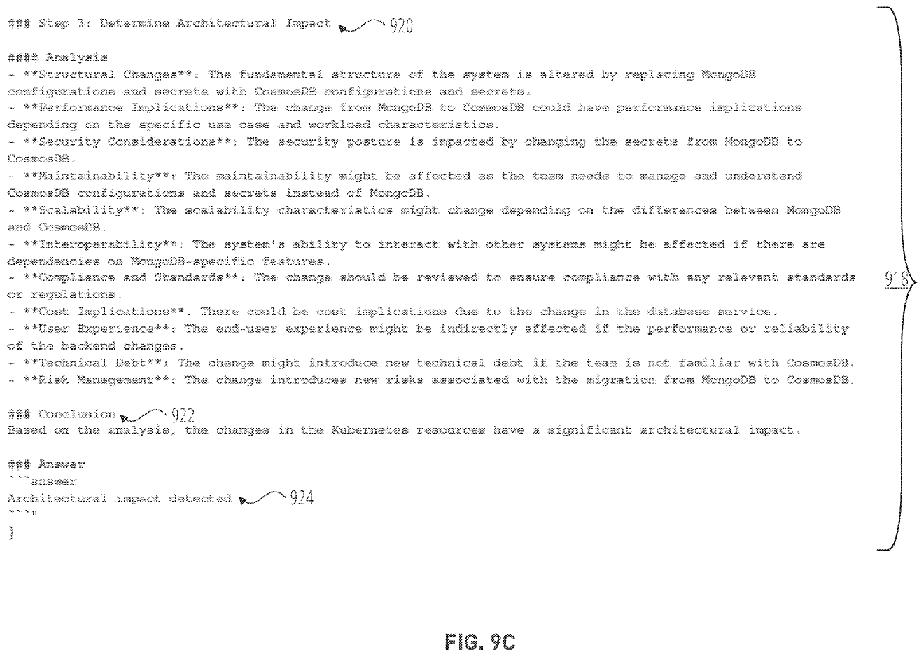

The following example, illustrated in full in the sequence of FIG. 8A-FIG. 8C, FIG. 9A and FIG. 9B-FIG. 9C, demonstrates the ability of this system to identify architectural impact.

FIG. 8A-FIG. 8C illustrates an example of relevant code changes in a pull request, in accordance with one embodiment. This can be obtained from subroutine block 302 (in FIG. 3), and block diagram 400 (in FIG. 4). The output shown in FIG. 8A-FIG. 8C provides code changes that are happening in sample (ServiceA) repository. The code changes includes use of connectivity and credential information of a new database, i.e., cosmos DB.

The output (shown in FIG. 8A-FIG. 8C) can serve as the input for subroutine block 304, eventually resulting in an architectural report produced by the system (or system output) that identifies this change and explains all the intermediate steps needed to arrive to that conclusion. The report also explains in detail the architectural concerns of this change. FIG. 9A-FIG. 9C illustrates an example of an Architecture Impact Report 900 based on the relevant code change shown in FIG. 8A-FIG. 8C.

FIG. 9A provides a summary 908 of the results of subroutine block 304; an embodiment of which is illustrated in FIG. 5. Thus, “Step 1: Build a DSL Representation of the System from the Kubernetes Manifest”, (item 902 shown in Architecture Impact Report 900), provides a summary of the results of subroutine block 304, including graphical representations of annotated changes tagged as <added> (904) and <deleted> (906).

FIG. 9B illustrates a summary of the results of subroutine block 306 as applied to the example shown in FIG. 8A-FIG. 8C, as part of Architecture Impact Report 900. An embodiment of subroutine block 306 is illustrated in FIG. 6. Thus, “Step 2: Identify the Changes in DSL Representation”, (item 912 shown in Architecture Impact Report 900), provides a summary of the results of subroutine block 306, including identification of changes tagged as <added> (916) and <deleted> (914).

FIG. 9C illustrates a summary 918 of the results of subroutine block 308 as applied to the example shown in FIG. 8A-FIG. 8C, as part of Architecture Impact Report 900. An embodiment of subroutine block 308 is illustrated in FIG. 7. Thus, “Step 3: Determine Architectural Impact”, (item 920 shown in Architecture Impact Report 900), provides a summary of the results of subroutine block 308, including a conclusion (922) and whether an architectural impact has been detected or not (item 924).

In summary, the Architecture Impact Report 900 illustrated in FIG. 9A-FIG. 9C provides a summary of what transpired in subroutine block 304, subroutine block 306 and subroutine block 308. Furthermore, since the Architecture Impact Report 900 is generated from an LLM, the process for producing Architecture Impact Report 900 is nondeterministic. That is, there can be different versions of Architecture Impact Report 900 that differ on the extent of details in the summary therein. However, the final conclusion (regarding architectural impact) is deterministic, and validated. That is, the final answer (for example, item 924) is correct in the Architecture Impact Report 900.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computing apparatus comprising:
a processor; and
a memory storing instructions that, when executed by the processor, configure the apparatus to:
receive code changes included in the pull request;
identify, from the code changes, one or more relevant code changes having a potential to cause architectural impact;
filter one or more irrelevant code changes from the code changes; and
annotate the one or more relevant code changes by encapsulating the one or more relevant code changes with one or more tags indicating a type of change.

2. The computing apparatus of claim 1, wherein when identifying the one or more relevant code changes, the apparatus is configured to:
provide a specialized prompt to a large language model configured to identify code changes having the potential to cause architectural impact.

3. The computing apparatus of claim 1, wherein the one or more tags comprise an added tag, a deleted tag, and a modified tag.

4. The computing apparatus of claim 1, wherein the one or more relevant code changes comprise code changes that alter structural relationships, introduce new dependencies, modify infrastructure configuration, or affect service interactions.

5. The computing apparatus of claim 1, wherein when filtering the one or more irrelevant code changes, the apparatus is configured to
filter at least one of unit tests, formatting changes, documentation changes, or cosmetic refactors.

6. The computing apparatus of claim 1, wherein the apparatus is integrated with a continuous integration and continuous deployment pipeline to provide real-time feedback of architectural impact during review of the pull request.

7. A non-transitory computer-readable storage medium, the computer-readable storage medium including instructions that when executed by a computer, cause the computer to:
receive code changes included in the pull request;
identify, from the code changes, one or more relevant code changes having a potential to cause architectural impact;
filter one or more irrelevant code changes from the code changes; and
annotate the one or more relevant code changes by encapsulating the one or more relevant code changes with one or more tags indicating a type of change.

8. The non-transitory computer-readable storage medium of claim 7, wherein when identifying the one or more relevant code changes, the computer is configured to:
provide a specialized prompt to a large language model configured to identify code changes having the potential to cause architectural impact.

9. The non-transitory computer-readable storage medium of claim 7, wherein the one or more tags comprise an added tag, a deleted tag, and a modified tag.

10. The non-transitory computer-readable storage medium of claim 7, wherein the one or more relevant code changes comprise code changes that alter structural relationships, introduce new dependencies, modify infrastructure configuration, or affect service interactions.

11. The non-transitory computer-readable storage medium of claim 7, wherein when filtering the one or more irrelevant code changes, the computer is configured to:
filter at least one of unit tests, formatting changes, documentation changes, or cosmetic refactors.

12. The non-transitory computer-readable storage medium of claim 7, wherein the non-transitory computer-readable storage medium is integrated with a continuous integration and continuous deployment pipeline to provide real-time feedback of architectural impact during review of the pull request.

13. A computer-implemented method for annotating code changes associated with a pull request, the method comprising:
receiving, by a processor, code changes included in the pull request;
identifying, by the processor, from the code changes, one or more relevant code changes having a potential to cause architectural impact;
filtering, by the processor, one or more irrelevant code changes from the code changes; and
annotating, by the processor, the one or more relevant code changes by encapsulating the one or more relevant code changes with one or more tags indicating a type of change.

14. The computer-implemented method of claim 13, wherein identifying the one or more relevant code changes comprises:
providing, by the processor, a specialized prompt to a large language model configured to identify code changes having the potential to cause architectural impact.

15. The computer-implemented method of claim 13, wherein the one or more tags comprise an added tag, a deleted tag, and a modified tag.

16. The computer-implemented method of claim 13, wherein the one or more relevant code changes comprise code changes that alter structural relationships, introduce new dependencies, modify infrastructure configuration, or affect service interactions.

17. The computer-implemented method of claim 13, wherein filtering the one or more irrelevant code changes comprises filtering at least one of unit tests, formatting changes, documentation changes, or cosmetic refactors.

18. The computer-implemented method of claim 13, wherein the method is integrated with a continuous integration and continuous deployment pipeline to provide real-time feedback of architectural impact during review of the pull request.
